(19) United States
(12) Patent Application Publication
(10) Pub. No.: US 2024/0379263 A1
(43) Pub. Date: Nov. 14, 2024

(54) Castable Ce-Based Magnets

(71) Applicant: Iowa State University Research Foundation, Inc., Ames, IA (US)

(72) Inventors: Andriy Palasyuk, Ames, IA (US); Olena Palasyuk, Ames, IA (US); Thomas A. Lograsso, Ames, IA (US); Matthew J. Kramer, Swoope, VA (US)

(21) Appl. No.: 18/656,675

(22) Filed: May 7, 2024

Related U.S. Application Data
(60) Provisional application No. 63/465,975, filed on May 12, 2023.

(51) Int. Cl. H01F 1/055; B22D 21/00; C22C 1/02; C22C 30/02

(52) U.S. Cl. CPC H01F 1/055; B22D 21/00; C22C 1/02; C22C 30/02; C22C 2202/02

(57) ABSTRACT

As-cast permanent magnets are provided that preferably have a main 1:7 Ce-based main matrix phase to achieve improved as-cast extrinsic magnetic properties using certain optimum casting conditions without the need for subsequent heat treatment. As-cast magnets also can be subjected to heat treatment to achieve similar improved extrinsic magnetic properties.

### RELATED APPLICATION

This application benefit and priority of U.S. provisional application 63/465,975 filed May 12, 2023, the entire disclosure and drawings of which are incorporated herein by reference.

### CONTRACTUAL ORIGIN OF THE INVENTION

This invention was made with government support under Grant No. DE-AC02-07CH11358 awarded by the U.S. Department of Energy. The government has certain rights in the invention.

### FIELD OF THE INVENTION

The present invention relates to permanent magnets and, in particular, to castable Ce-based permanent magnet alloys that reduce or eliminate dependence on scarce, critical rare earth (RE) elements well as methods for casting these alloys in the form of as-cast permanent magnets without powder processing.

### BACKGROUND OF THE INVENTION

There exists a “GAP” (an empty niche of magnetic energy products) between the present-day low-flux (ferrites, Alnico) and high-flux (Nd₂Fe₁₄B-type and SmCo₅-type magnets). For example, there is interest in so-called “GAP MAGNETS” that reach energy products of about 10-20 MGOe or above and that reduce the use of rare earth alloying elements to achieve such improved energy products in the magnet.

Certain known SmCo Series 2:17 permanent magnets are available commercially and achieve improved extrinsic magnetic properties, such as higher energy products. These commercial magnets have a 2:17 matrix (Sm₂Co₁₇) that is produced only after extensive powder metallurgy processing that includes ingot casting, ingot grinding to produce powder, powder compaction to form a compact, compact sintering, compact heat treatment, machining to achieve a final shape, and others.

CeCo₅-based magnets, forerunners of present Ce-based gap magnets (CGMs), were discovered in the late 60's. Different aspects of their properties and processing are described in numerous publications ever since. These materials are largely perceived as inferior analog of SmCo magnets, as their (BH)max rarely exceeds 10 MGOe. Although CGMs and SmCo are very similar, they share the same basic crystal structure and follow similar structural and microstructural variations. Pragmatically, the preference is always given to magnetically stronger SmCo. Because of record high magneto-crystalline anisotropy, facilitated by Sm rather than Ce, they exhibit better coercivity, overall magnetic performance and energy products exceeding 30 MGOe. However, there is one key advantage of CGMs in comparison to SmCo, i.e., lower than SmCo temperatures of phase transformations. This leads to better microstructure control and creates a potential for processing routes that are alternative to the those regularly used for magnet production, e.g., powder processing and sintering. Although the modern CGMs show lower than SmCo magnetic characteristics, these are achieved readily during casting, with very square magnetic hysteresis loops, without powder processing steps, using no critical rare earths, and with lower than SmCo contents of Co. In fact, the Co contents are comparable to alnico, i.e., the commercial low-flux niche market magnet. CGMs combine strong performance with easy processing, which generate price/performance ratios acceptable for middle energy magnet applications.

CGMs, both 1:5- and 1:7-type systems, exhibit intra-granular coercivity mechanism. Coercivity appears readily after thermodynamic transformation of each grain of cast material during cooling, like it occurs in alnico magnets. However, in contrast to alnico's spinodal transformation causing nano-structuring of each individual grain and thus generating extrinsic magnetic characteristics, in CGMs magnetic hardness emerges because of the reduced solubility of main magnetic matrix at low temperatures. During the heat treatment, the microstructure of strictly anisotropic nonmagnetic lamellar stacking faults and/or intercalated regions develops within each grain of the matrix inducing magnetic hardness of the material. Sintering to gain magnetic domain wall pinning is not required, therefore nano-sized single-crystal, single-domain powder and grain boundary engineering are not needed. Apparently, costly, and hazardous powder processing steps currently used in modern magnet production may be eradicated, which simplifies and greatly economizes the manufacturing to potentially a one-step operation, which includes melting and controlled cooling.

There is a need for a Ce-based permanent magnet alloy that reduces or eliminates dependence on rare earth (RE) elements, cobalt (Co), and other scarce elements and that can be directly cast to have improved extrinsic magnetic properties, such as improved energy products, without the need for powder metallurgy processing of the type described above needed to produce the SmCo Series 2:17 magnets.

### SUMMARY OF THE INVENTION

The present invention addresses this need by providing Ce-based permanent magnet alloys having compositions that render them castable using certain casting parameters pursuant to method embodiments of the present invention.

Certain embodiments of the present invention provide as-cast Ce-based permanent magnets that preferably have a predominant 1:7 Ce-based main matrix phase for improved as-cast extrinsic magnetic properties using optimum casting conditions without the need for subsequent heat treatment. Other embodiments envision using other casting conditions to produce an as-cast Ce-based magnet that is subjected to a simple aging heat treatment to achieve similar extrinsic magnetic properties.

To this end, certain embodiments of the present invention provide castable Ce-based (or Ce-modified) alloys having compositions (in atomic %) of: 7% to 15.2% Ce, 0 to 7.0% Sm, 1% to 2% Zr, 48% to 62% Co, 15% to 25% Fe, and 9.5% to 11.5% Cu, and that can be cast using certain casting embodiments of the present invention to reduce the formation of the soft magnetic 2:17 phase and other soft magnetic phases during casting to yield a cast microstructure having a predominant 1:7 Ce-based matrix phase represented by Ce(Zr,Co,Fe,Cu)₇ for Sm-free alloys in the as-cast condition or as-cast/heat-treated condition. The 1:7 main matrix phase is represented by (Ce,Sm)(Zr,Co,Fe,Cu)₇ for Sm-substituted alloys. These alloy embodiments can be produced by a one-step casting-to-solidification process, as well as by bottom pour casting (BPC) from a melting vessel into a mold wherein the alloy is cooled and solidified. With respect to certain BPC embodiments, the alloy composition may have a Ce-rich content of about 13.8 to about 14.5 atomic % to promote more congruent solidification of the 1:7 main matrix phase from the melt.

Certain particular embodiments of BPC castable Ce-based alloys having modified compositions (in atomic %) of: 13.5% to 15.2% Ce, 0 to 4.0% Sm, 1.6% to 2.5% Zr, 51% to 58% Co, 16.5% to 22.5% Fe, and 10.1% to 11.2% Cu wherein the alloys are referred to as Ce-based alloys since only Ce and an optional small content of Sm above is/are present as the rare earth alloying element(s).

Certain embodiments of the present invention provide castable Ce-based (or Ce-modified) alloys having compositions (in atomic %) of: 7% to 14.2% Ce, 0 to 7.0% Sm, 1% to 2% Zr, 48% to 62% Co, 15% to 25% Fe, and 9.5% to 11.5% Cu, and that can be cast using certain casting embodiments of the present invention to reduce the formation of the soft magnetic 2:17 phase and other soft magnetic phases during casting to yield a cast microstructure having a predominant 1:7 Ce-based matrix phase represented by Ce(Zr,Co,Fe,Cu)₇ for Sm-free alloys in the as-cast condition or as-cast/heat-treated condition. The 1:7 main matrix phase is represented by (Ce,Sm)(Zr,Co,Fe,Cu) 7 for Sm-substituted alloys.

Other certain particular embodiments provide castable Ce-based alloys having modified compositions (in atomic %) of: 13.8% to 14.5% Ce, 0 to 4.0% Sm, 1.6% to 2.5% Zr, 51% to 58% Co, 16.5% to 22.5% Fe, and 10.1% to 11.2% Cu.

Certain method embodiments of the present invention can be employed to cast the above-described alloys wherein for a given weight of alloy charge, the temperature/time profile beginning from a superheat temperature above the alloy melting point is controlled to reduce the formation of the secondary soft magnetic impurity phase(s) during casting to yield a cast microstructure having predominant 1:7 Ce-based main matrix phase in the as-cast condition, or in the optional as-cast/heat-treated condition. Method embodiments control casting and/or heat treatment parameters to also form magnetically beneficial (REE,Co)-rich phase(s) at stacking faults in the matrix crystal lattice, such as (Ce,Co)-rich or (Ce/Sm,Co)-rich stacking fault phase(s) depending upon whether the alloy includes Sm or not.

As a result, other embodiments of the present invention envision a Ce-based permanent magnet having a microstructure that comprises the aforementioned predominantly 1:7 Ce-based main matrix phase having magnetically beneficial (REE,Co)-rich phase(s) at stacking faults in the matrix crystal lattice and having secondary soft magnetic impurity phases in the matrix in very minor amount such as less than 10 volume %, preferably 5-8 volume %, of the overall microstructure in the as-cast condition or as-cast/heat treated condition. REE can be Ce or both Ce and Sm.

Embodiments of the present invention are advantageous to reduce or eliminate dependence on scare, critical rare earth elements (REE)'s as well as nearly critical cobalt (Co) in the manufacture of cast permanent magnets and yet provide energy product values that are similar to or beyond 20 MGOe with no powder processing steps.

The present invention will become more readily understood from the following detailed description taken with the drawings.

### BRIEF DESCRIPTION OF THE DRAWINGS

FIG. 1 contains Table 1 which shows alloy compositions of Examples 1-7. In Table 1, the column % Sm means percentage of Ce for Sm substitution.

FIG. 2 contains Table 2 which shows Examples #1-1-#1-4 and #3-1 of casting and scale-up experiments including loading compositions for each indicated kilogram (kg) load, selective EDS composition determinations of the casting, and magnetic properties. In Table 2: (*): Commercial purity cerium was used for all casting experiments and acquired from ACI ALLOYS, INC (ACI, 99.9% Ce). AC is as-cast material. HT is heat-treated material where:
(**): heat 1-1.5 h to 1350° C. (hold 5-10 min) then bottom pouring into water-chilled Cu-mold-then radiant cooling to room temperature (RT).
(***): heat 1-1.5 h to 1220° C. (hold 40 min) then radiant cooling to RT.
(****): heat 1-1.5 h to 1165° C. (hold 10 min) then 1160° C. (hold 1 h) then 1030° C. (hold 4 h) then radiant cooling to RT.
(*****): heat 1-1.5 h to 1160° C. (hold 1 h) then 1040° C. (hold 4 h) then radiant cooling to RT. Standard heat treatment: 1040° C. (hold 10 h) then at 10° C./min to 400° C. (hold 6 h) then furnace cool to RT.
   The final radiant cooling to room temperature was conducted before the as-cast puck material was removed from the crucible in the vacuum induction system (Ames Laboratory, Materials Preparation Center, LEPEL 480V Generator, 200 mm diameter, 180 mm long induction coil).

FIG. 3 shows M/H hysteresis loops of samples of the Examples #1 through #7 of Table 1 after casting and heat treatment.

FIGS. 4a and 4b are X-ray diffraction patterns of Example #1 through #7 (Table 1) before (FIG. 4a) and after heat treatment (FIG. 4b).

FIGS. 5a; 5b; and 5c are respective X-ray diffraction patterns of Example #1-2 FIG. 5a; Example #1-3 (FIG. 5b) and Example #1-4 (FIG. 5c) listed in Table 2. In FIGS. 5a, 5b and 5c, the diffraction patterns are shown with the “reference” pattern at the bottom, the “as-cast” pattern in the middle, and “heat treated” pattern at the top.

FIGS. 6a and 6b are SEM backscattered electron image (×1500 magnification) of as-cast Sm-free alloy button microstructure of Example #1 of Table 1 before heat treatment (FIG. 6a) and after heat treatment (FIG. 6b), which shows a predominant (main) 1:7 matrix phase having (Ce,Co)-rich 2:7/5:19 phases of lamellar structure and/or intercalated regions therein wherein the lamellar structures subsequently are transformed to stacking faults along the basal planes of matrix crystal lattice.

FIG. 7 contains Table 3 which shows Examples #1-5 and #2-1 of further casting and scale-up experiments including loading compositions for each indicated kilogram (kg) load, selective EDS composition determinations, and magnetic properties. In Table 3, the column % Sm means percentage of Sm substituted for Ce. The casting parameters in Table 3: (Ce*): Cerium and Samarium that were used for casting experiments were acquired from ACI ALLOYS, INC (ACI, 99.9% Ce and ACI, 99.9% Sm). BPC is bottom pour casting (from 2.3 kg alumina crucible with 10 mm diameter bottom discharge hole) where: BPC is heat 1-1.5 h to 1380° C. (hold 5-10 min) then bottom pour into water-chilled Cu-mold then radiant cooling to RT and where m1220° C. (*) is heat 1-1.5 h to 1220° C. (hold 40 mins) then to 1040° C. (hold 4 h) then radiant cooling to RT. Standard heat treatment: 1040° C. (hold 10 h) then at 10° C./min to 400° C. (hold 6 h) then furnace cool to RT.

FIGS. 8a and 8b are X-ray diffraction patterns of Example #1-5 (Table 3) before and after heat treatment (FIG. 8a), and Example #2-1 (Table 3) after heat treatment (FIG. 8b). In FIG. 8a, the diffraction patterns are shown with the “reference” pattern at the bottom, the “as-cast” pattern in the middle, and “heat treated” pattern at the top. In FIG. 8b the “reference” pattern is the lower dashed pattern.

FIG. 9 is an SEM backscattered electron image (×1500 magnification) of alloy button microstructure of Example #1-5 of Table 3 prepared using BPC technique, and after heat treatment, which shows a predominant (main) 1:7 matrix phase having (Ce,Co)-rich 2:7/5:19 phases of lamellar structure and/or intercalated regions therein wherein the lamellar structures subsequently are transformed to stacking faults along the basal planes of matrix crystal lattice.

FIG. 10a; 10b show M/H hysteresis loops of samples of the Examples #1-5 and #2-1 of Table 3 after standard heat treatment, dash lines are the lab-scale references of Table 1 (Example #1 and #2, respectively).

### DESCRIPTION OF THE INVENTION

Certain embodiments of the present invention provide as-cast permanent magnets that preferably have a predominantly 1:7 Ce-based matrix phase represented by Ce(Zr,Co,Fe,Cu)₇ or (Ce,Sm)(Zr,Co,Fe,Cu)₇, depending upon whether the alloy is Sm-free or not, to provide improved as-cast extrinsic magnetic properties using optimum one-step casting conditions without the need for subsequent heat treatment. Other embodiments envision using casting conditions that may be less than optimum to produce an as-cast permanent magnet having Ce-based main matrix phase that can be subjected to a simple aging heat treatment to achieve similar extrinsic magnetic properties.

Certain embodiments of the present invention provide castable Ce-based (or Ce-modified) alloys that have a composition (in atomic %) of: 7% to 15.2% Ce, 0 to 7.0% Sm, 1%-2% Zr, 50% to 60% Co, 15% to 25% Fe, and 9.5% to 11.5% Cu, and that can be cast using certain casting embodiments of the present invention to reduce the formation of the soft magnetic 2:17 impurity phase and other soft magnetic impurity phases during casting to yield a cast microstructure having predominantly a 1:7 Ce-based main matrix phase having beneficial (REE,Co)-rich phase(s) at stacking faults in the matrix crystal lattice in the as-cast condition or as-cast and heat-treated condition. These alloy embodiments can be produced by a one-step casting/cooling-to-solidification, such as by bottom pour casting (BPC) from a melting vessel into a mold wherein the alloy is solidified.

Certain particular embodiments provide castable Ce-based alloys having modified compositions of (in atomic %): 13.5% to 15.2% Ce, 0 to 4.0% Sm, 1.6% to 2.5% Zr, 51% to 58% Co, 16.5% to 22.5% Fe, and 10.1% to 11.2% Cu.

Other certain embodiments of the present invention provide castable Ce-based (or Ce-modified) alloys that have a composition (in atomic %) of: 7% to 14.2% Ce, 0 to 7.0% Sm, 1%-2% Zr, 50% to 60% Co, 15% to 25% Fe, and 9.5% to 11.5% Cu, and that can be cast using certain casting embodiments of the present invention to reduce the formation of the soft magnetic 2:17 impurity phase and other soft magnetic impurity phases during casting to yield a cast microstructure having predominantly a 1:7 Ce-based main matrix phase having beneficial (REE,Co)-rich phase(s) at stacking faults in the matrix crystal lattice in the as-cast condition or as-cast/heat-treated condition.

Other certain embodiments provide castable Ce-based alloys having compositions of (in atomic %): 13.8% to 14.5% Ce, 0 to 4.0% Sm, 1.6% to 2.5% Zr, 51% to 58% Co, 16.5% to 22.5% Fe, and 10.1% to 11.2% Cu.

Method embodiments of the present invention involve casting the above-described alloys wherein for a given weight of alloy charge, the casting temperature/time profile begins from a superheat temperature just above the particular alloy melting temperature so that the formation of the magnetically deleterious secondary soft magnetic impurity phase(s) such as the 2:17 phase and/or Fe/Co containing phases are reduced during cooling and solidification to yield a cast microstructure having predominant a 1:7 main matrix phase having the magnetically beneficial (REE,Co)-rich phase(s) at stacking faults in the matrix crystal lattice in the as-cast condition, or optionally in the as-cast/heat-treated condition (if casting parameters may not be optimum) wherein coercivity is greatly improved by the presence of these (REE,Co)-rich stacking fault phases.

The following Examples are offered for purposes of illustrating the embodiments of the invention without limiting the scope of the invention.

### Initial Lab-Scale Examples #1-7

Arc-melted 8-9 g buttons of Examples #1-7 (Table 1) were prepared in a conventional arc-melter on a water-cooled copper hearth under Ar-gas atmosphere. Buttons were flipped and re-melted three times to ensure full mixing and homogenization. The as-cast ingot exhibited a clear columnar grain structure. After arc-melting and solidification on the copper hearth, the buttons were wrapped into Ta-foil, and placed into evacuated fused silica containers to undergo a so-called standard heat treatment, i.e., 1040° C. (1 h)→10° C./min.→400° C. (6 h)→furnace cool to room temperature (RT).

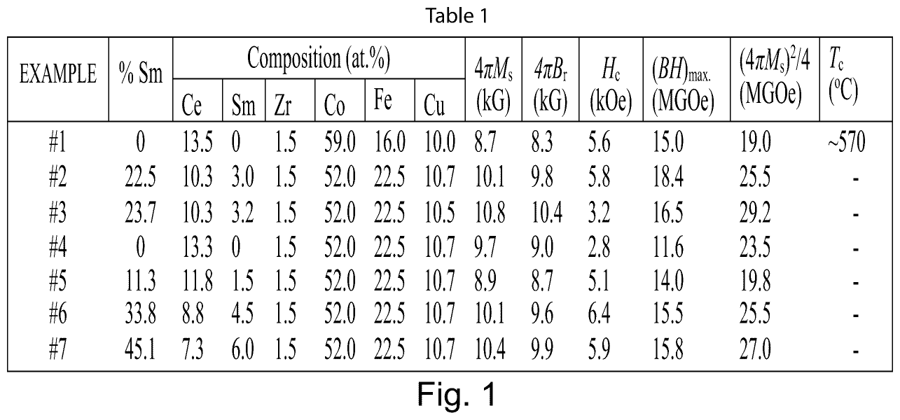

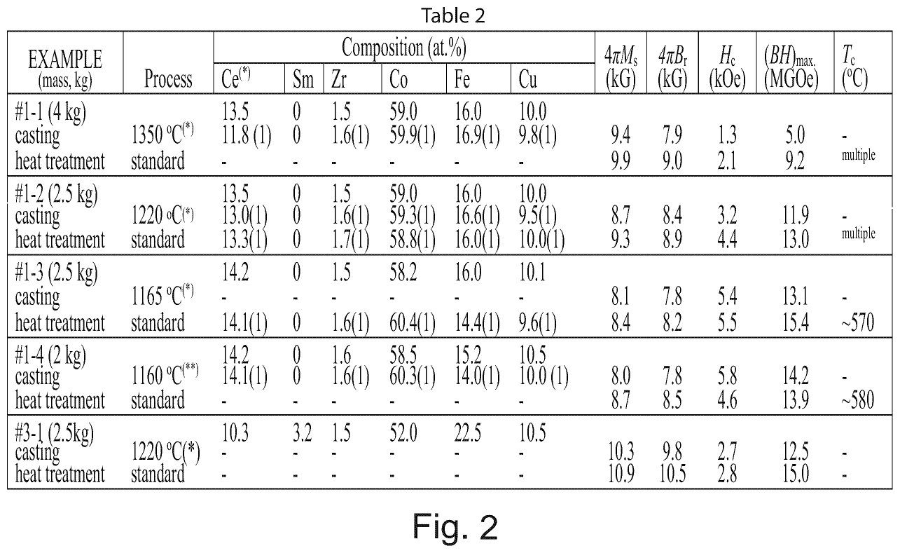

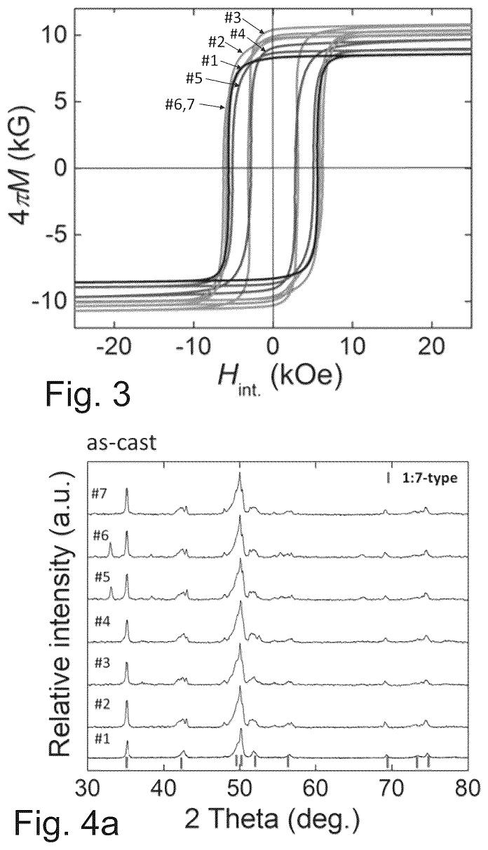

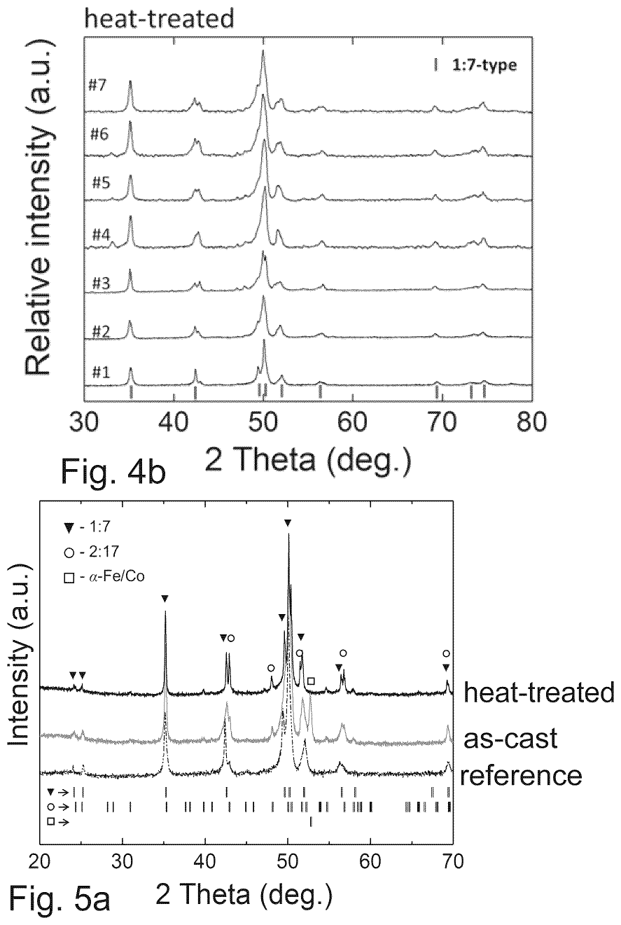

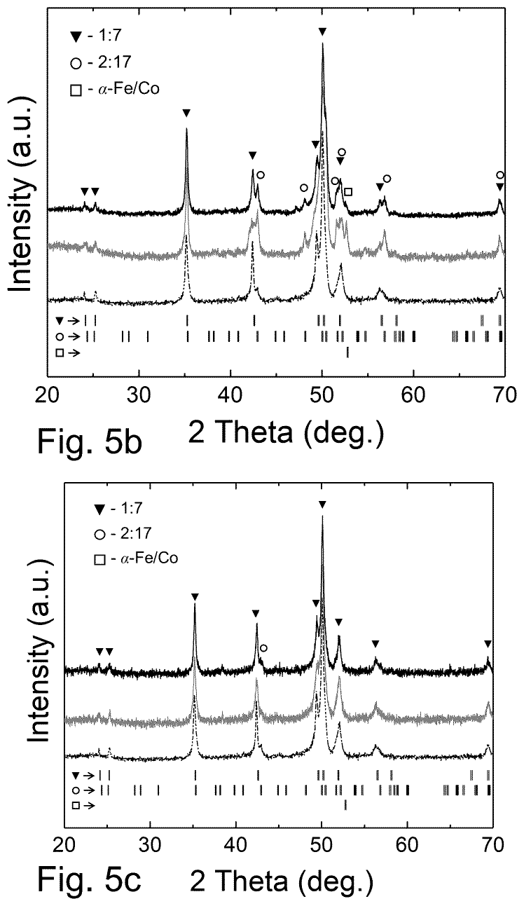

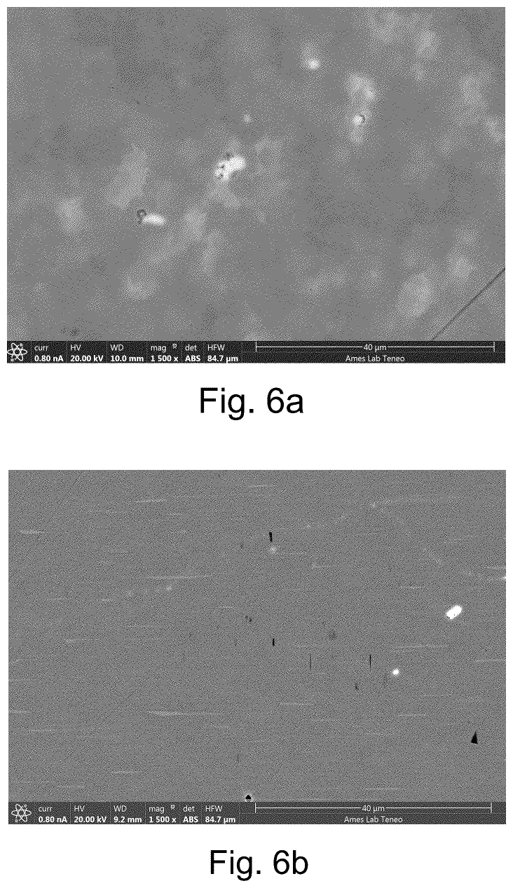

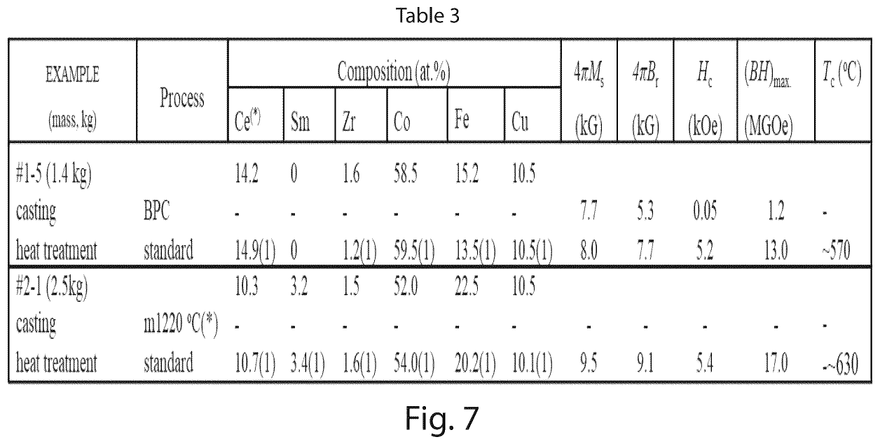

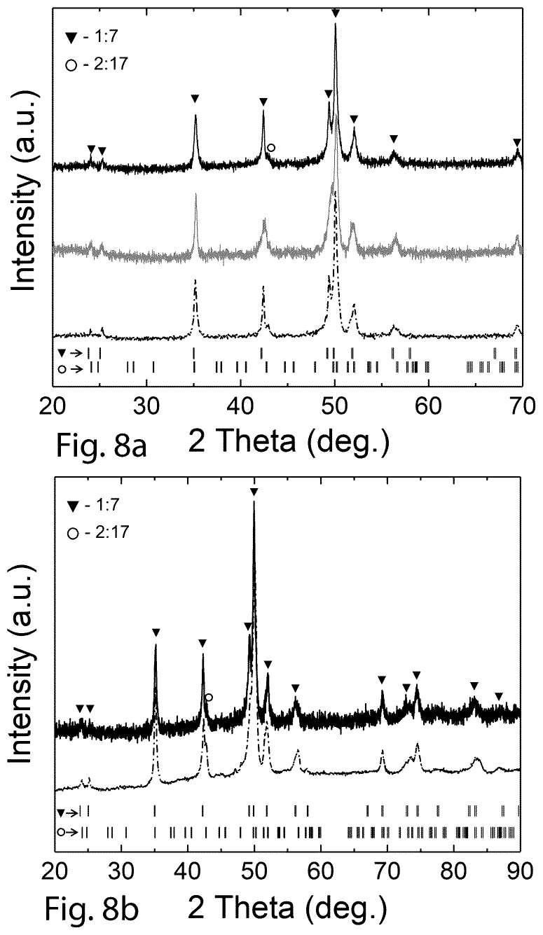

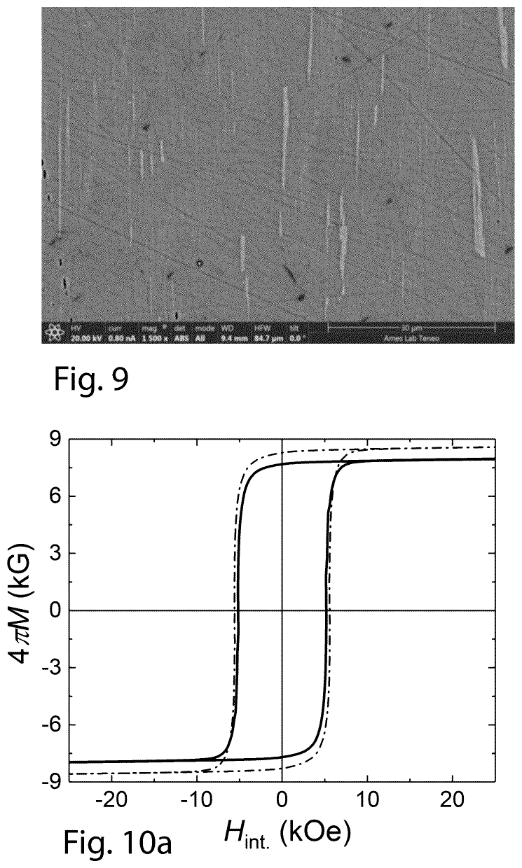

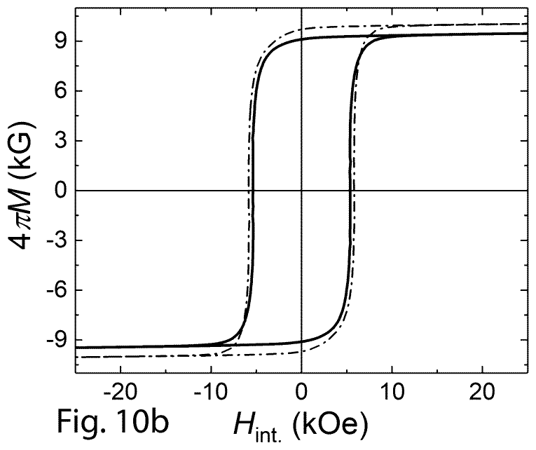

Compositions of the Examples #1-7 and their magnetic properties are presented in Table 1 (see FIG. 1). Magnetic measurements were performed on small amounts (about 30-50 mg) of crushed heat treated samples (particle size <32 μm), mixed with wax and aligned in a magnetic field. Their saturation magnetizations (4TTMs), remanences (4TTBr), coercivities (Hc) and maximum energy products (BH)max, are collected in Table 1.

High magnetic properties were observed readily after the typical heat treatment (Table 1). The maximum energy products (BH)max. of 15-18 MGOe are about 70% of their theoretical values (4πM²ₛ)/4. Optimization of the temperature/time regime as well as heat treatment if needed will further improve extrinsic characteristics, e.g., coercivity and shape of the hysteresis, so that >90% of the theoretical performance is possible.

The X-ray diffraction patterns of all the examples in as-cast and heat-treated condition are presented in FIGS. 4a and 4b. Interestingly, the major Bragg reflections can be easily indexed within the hexagonal TbCu₇-type crystal structure, which indicates that the matrix of the material in both as-cast and heat-treated samples, is predominantly of 1:7-type. Typically, the 1:7-type phase material is the high-temperature metastable phase, which undergoes significant decomposition after the heat treatment. However, the inventors observed that the 1:7-type matrix in the cast bulk material after the heat treatment exhibited observable extrinsic magnetic characteristics, e.g., coercivity. This result is unique and very different to what is typically observed in commercial SmCo permanent magnets wherein the matrix comprises 2:17-type material and wherein their extrinsic magnetic properties appear only after nano-structuring (e.g. grinding) cast material, compaction, and heat treatment, i.e., additional processing steps that are not needed for practice of embodiments of the present invention.

SEM backscattered-electron images from the polished surfaces of the as-cast and heat-treated materials demonstrated that the as-cast samples contained a mixture of phases, FIG. 6a, with very close in chemical compositions to the 1:7 matrix phase with slight variations without clearly defined phase boundaries. After the heat treatment, the microstructure becomes predominantly bimodal and comprises a predominant 1:7 Ce-based main matrix phase with magnetically beneficial phase(s) being present in minor amount as linear (Ce,Co)-rich 2:7/5:19-type stacking faults and intercalated layers, FIG. 6b. These phases appear to be (Ce,Co)-rich in composition and form as striped lamellar secondary impurity phases along basal planes of matrix crystal lattices. The retention of the high temperature metastable 1:7 matrix phase after the aging heat treatment was observed and quite unexpected.

Although not wishing to be bound by any theory, there appears to be some kind of structural ordering without phase decomposition of the predominant 1:7 matrix phase. For example, solidification of the main high temperature metastable 1:7-type phase appears to occur through peritectic reaction between the molten liquid alloy and the secondary phases (2:17 and/or a-Fe-type Fe/Co), i.e., represented tentatively by: L (liquid)+2:17->1:7 (main phase). However, the thermodynamic transformation appears to be rather “shallow”; i.e., with a small amount of solid secondary phases in equilibrium with the liquid.

This peritectic reaction was a potential experimental hurdle to be overcome to achieve a one-step casting process improvement as described below. To this end, the maximum temperature of the casting process embodiment should be just above the melting temperature of the particular alloy (e.g. about 5-10° C. above the alloy melting temperature 1160° C.) because its increase beyond that exacerbates formation of the 1:7 Ce-based main matrix phase, while yet the maximum temperatures need to high enough to fully melt the starting charge metals.

### Further Kilogram-Scale Examples

An object of embodiments of the present invention after the lab-scale experiments (Table 1) was to produce kg-scale material in one continuous (one step) process that incorporated induction melting, gradual cooling and optional aging heat treatment with the ultimate result being a kg-scaled magnet material with fully developed extrinsic magnetic characteristics, matching and/or exceeding those of the lab-scale samples (Table 1). Also, another object was to use industrial purity Ce to prove viability of both the chemistry and the process for industrial type production.

The initial experimental involved melting/solidification steps of the casting process wherein the starting 2-2.5 kg of properly weighed metals in form of chunks were loaded into alumina (Al₂O₃) cylindrical tubular crucible with a closed bottom wall having a pour opening closed by an Al₂O₃ stopper rod fit into the opening. A thermocouple that controls the process temperature was placed into the stopper rod and touched the bottom-center of the crucible. The metal chunks were placed in the crucible so that the low-melting elements were predominantly placed on the top, i.e., chunks of Ce, to allow better mixing and reactivity. Then, the crucible was placed in an induction melter, and then the melter system was evacuated for 24 hours thereafter. After backfilling with Ar to about 80% of normal atmospheric pressure, the metal charge is induction heated to the casting temperatures shown for Table 2 (FIG. 2).

Based on the results of the experiments of Example #1-1 the extensive presence of soft magnetic impurities was detected using the casting parameters set forth described above of FIG. 2 (FIG. 5a). Thus, the remaining examples of Table 2 were melted and solidified in the crucible itself (i.e., without bottom pouring) so that a controlled lower superheat temperature could be used. In the no-pour Examples #1-2; #1-3, #1-4, the alloy material was melted and solidified in-situ in the crucible (without pouring) in the form of as-cast hockey puck shaped sample with a center hole from the stopper rod. Example #3-1 also was melted and solidified in-situ in the crucible (without pouring) as an initial trial to cast the Sm-substituted alloy whose loading composition is shown in Table 2, FIG. 2.

To this end, in Example #1-2, a maximum temperature of 1220° C., (being lower as in #1-1 and closer to peritectic point 1160° C.) was used for the 2-2.5 kg charge mass (metal chunks) to increase chances for melt homogeneity at reduced temperatures. Two 2.5-kg runs, and one 2-kg run of Example #1-2 alloy composition were performed to study and adjust melting process thermal parameters, as well as slightly adjust (modify) composition of Example #1-1 alloy towards higher Ce content (see Table 2 for modified alloy compositions of Examples #1-2, #1-3, and #1-4). Minor (˜0.7 at. %) increase of Ce content facilitates better single-phase formation of the matrix material.

After removal from the crucible, the as-cast puck samples were subjected to a standard heat treatment for all cast melts prepared. Magnetic (M/H), structural (XRD, SEM) and thermal (DSC) characteristics were evaluated. The results of the casting runs are presented in Table 2.

The as-cast 2.5-kg material (as-cast puck sample) of Example #1-2 appeared to be uniform, suggesting sufficiency of the heat provided for complete induction melting of the 2.5 kg of metal chunks in 40 minutes time. However, structural evaluation reveals strong presence of the secondary soft magnetic impurity phases, i.e., 2:17 and/or Fe/Co. Even after the heat treatment, the presence of these soft magnetic impurity phases degrades magnetic performance. FIG. 5b shows XRD pattern of the as-cast, heat-treated puck sample of Example #1-2 with additional Bragg reflections (emphasized) from the presence of secondary impurity phases in the heat-treated puck material. This is reflected in the (BH)max. of 13.0 MGOe, i.e., about 87% of the lab-scale sample (BH)max value of 15.0 MGOe. Nonetheless, the volume fraction of these impurities in Example #1-2 was significantly reduced compared to that of Example #1-1, FIG. 5a.

In contrast to the casting run of Example #1-2, the results of Examples #1-3 and #1-4 started to approach the lab-scale results (of Table 1) and suggested minimal sensitivity to Ce purity. Example #1-3 involved reducing the maximum superheat temperature to 1165° C. (see Table 2) and incorporating an additional melt dwell (hold) step. Further reduction of maximum temperature to 1165° C., accompanied with the intermediate dwelling step at 1030° C. for 4 hours below the alloy melting temperature (1160° C.), yielded brittle, large-grained cast puck sample with magnetic characteristics exceeding the lab-scale sample. The (BH)max of the as-cast alloy was about 85% of that of the fully thermally treated sample. This suggested that the temperature-time profile of casting process was progressing toward more optimum casting conditions.

However, the upper part of the Example #1-3 solidified puck sample contained unreacted Fe/Co pieces (1/5 of the total puck height may be removed). The middle and bottom regions of the puck sample were uniform and consistent, and XRD patterns, FIG. 5c, of these regions of Example #1-3 puck material exhibited virtually no difference from FIG. 4b (Example #1, used as a reference XRD).

An SEM backscattered electron image of the heat-treated Example #1-3 puck material of the (middle and bottom regions) indicated no presence of the above-described deleterious soft magnetic impurity phases. The results of Example #1-3 suggested that casting conditions were being controlled to better emulate the lab-scale casting temperature/time profile and could be further optimized as one-step casting process. One drawback of the Example #1-3 casting process was presence of unreacted material (mostly Fe/Co, about 7-10 grams) that caused compositional inhomogeneity in the upper part of the ingot. This is an inherent disadvantage of the in-situ method in general, as the full melt mixing is hard to achieve without significant superheating and melt pouring.

In the casting process of Example #1-4 (1160° C.) (see Table 2), the casting parameters were adjusted so that the intermediate dwelling period was performed at slightly higher optimized temperature of 1040° C. below the alloy melting temperature (1160° C.), and the total mass of the material was reduced to optimized 2 kg. These optimizing adjustments significantly improved results of the casting process and demonstrated achievement of a successful one-step casting process of a Ce-based magnet. In particular, the as-cast Example #1-4 puck material was uniform, brittle, and large-grained (average grain size of 100-400 μm) throughout and reached about 95% of the lab-scale magnetic performance (BH)max.

Moreover, XRD pattern, FIG. 5c, of the as-cast puck material exhibited virtually no difference from the reference XRD patterns of FIG. 4b (Example #1). The microstructure of the as-cast alloy was quite similar at 1500×, to lab-scale heat-treated alloy, FIG. 6b, showing the 1:7 phase as the Ce-based main matrix phase and striped lamellar 2:7/5:19 (Ce,Co)-rich phases dispersed in the matrix phase in very small volume %, such as about 5-8 volume %, but not yet fully transformed by heat treatment to stacking faults in the 1:7 matrix phase. Example #1-4 shows that one-step process of obtaining Ce-based magnet with fully developed microstructure identical to lab-scale reference is feasible without the separate heat treatment in case the cooling emulates the standard heat treatment (Table 2).

Example #3-1 of Table 2 was an initial trial in-situ casting/standard heat treatment of the Sm-substituted alloy composition of Table 2, FIG. 2. Example #3-1 achieved an energy product of 15 MGOe comparable to that (17 MGOe) of a subsequent Example #2-1 (Table 3, FIG. 7) of a Sm-substituted alloy in-situ cast and then heat treated as described below with respect to FIG. 7.

### Still Further Kilogram-Scale Examples. The Ex-Situ Method and Sm-Substituted Alloy

Although the described above in-situ method was feasible for obtaining kilograms of high-quality material, it also represents significant limitations. These include lacking compositional consistency and material uniformity, porosity, significant fracturing, and not full density of the solidified material. Unfortunately, the in-situ magnet preparation excludes pouring the melt, significantly hindering versatility of the proposed technology towards the near net-shape manufacturing of fully dense permanent magnet.

The additional alloy embodiment can be produced ex-situ, by casting/solidification, such as by bottom pour casting (BPC) from a melting vessel into a mold wherein the alloy is solidified. For the successful BPC, the melting crucible used for the in-situ method must be modified to increase the speed of the melt-pouring e.g., by increasing the diameter of crucible bottom hole from 5 to 10 millimeters and reducing the size of the crucible itself from 9.3-kg to 2.3-kg type Al₂O₃ crucible. The horizontal surface area of the bottom of the crucible is decreased, minimizing possible material deposits and incomplete mass transfer. This facilitates the completeness of the pour. For practice of certain BPC method embodiments, a Ce content of 13.8 to about 14.5 atomic % may facilitate more congruent formation of 1:7 matrix matrix phase from the melt and minimizes affects described in [0041] and [0042].

The nearly complete (>90% yield) BPC of Ce-based (Sm-free) alloy was achieved using the method described for Table 3 of FIG. 7. Chunks of starting metals, 1.4-kg charge, were placed into the alumina crucibles, then induction-heated to 1380° C., held at that temperature for 10 minutes, then poured the melt into water-chilled Cu-mold with subsequent radiant cooling to room temperature (RT). FIG. 8a shows XRD patterns of the as-cast and heat-treated alloy material in comparison to the reference material of FIG. 4b (Example #1). That is, FIGS. 8a and 8b are X-ray diffraction patterns of Example #1-5 (Table 3) before and after heat treatment (FIG. 8a), and Example #2-1 (Table 3) after heat treatment (FIG. 8b). FIG. 9 shows the microstructure that is similar to the examples obtained without BPC and to the reference material, FIG. 6a. FIG. 10a shows the magnetic hysteresis of the heat-treated BPC alloy in comparison to the lab-scale reference in Table 1 (Example #1), showing about 87% of the reference (BH)max, i.e., 13 MGOe. Further BPC optimization can be implemented to achieve 15 MGOe or 100% of the reference.

A further Example #2-1 of FIG. 7 involved using the in-situ casting conditions adjusted to cast a Sm-substituted alloy composition (see Table 3 of FIG. 7). That is, chunks of starting metals were loaded into an alumina crucible, induction-heated for 1-1.5 hours to 1220° C., held at that temperature for 40 minutes, then cooled to 1040° C., held at that temperature for 6 hours, and radiantly cooled to room temperature. FIG. 10b shows that magnetic properties of the 2.5-kg cast Sm-substituted puck material approached those of the reference lab-scale Example #2 (Table 1) and is the first castable Ce-based magnet with (BH)max=17 MGOe. Further casting process optimization can be implemented to achieve similar results as in Sm-free kg-scale ingots (Table 1). One observation of this large-scale experiment was confirmation of the principal feasibility of such casting process conditions, considering the high vapor pressure of Sm. Despite this factor, no considerable mass losses of Sm were experienced.

Although certain embodiments of the present invention have been described for purposes of illustration, those skilled in the art will appreciate that the present invention is not limited to such embodiments within the scope as set forth in the appended claims.

We claim:

1. A permanent magnet including a microstructure having a 1:7 Ce-based main matrix phase for improved extrinsic magnetic properties.

2. The magnet of claim 1 that includes (REE, Co)-rich phase(s) at stacking faults of the matrix phase wherein REE can be Ce or Ce and Sm.

3. The magnet of claim 1 that includes a secondary magnetic impurity phase dispersed in the main matrix phase in an amount of 5 to 8 volume %.

4. The magnet of claim 1 that is as-cast.

5. The magnet of claim 1 that is cast, and heat treated.

6. A permanent magnet alloy casting having a composition (in atomic %) of: 7% to 15.2% Ce, 0 to 7.0% Sm, 1%-2% Zr, 48% to 62% Co, 15% to 25% Fe, and 9.5% to 11.5% Cu, wherein the alloy casting has a microstructure having a 1:7 Ce-based main matrix phase in the as-cast condition or in the cast and as-heat treated condition.

7. The alloy casting of claim 6 having a composition (in atomic %) of 13.5% to 15.2% Ce, 0 to 4.0% Sm, 1.6% to 2.5% Zr, 51% to 58% Co, 16.5% to 22.5% Fe, and 10.1% to 11.2% Cu.

8. A permanent magnet alloy casting having a composition (in atomic %) of: 7% to 14.2% Ce, 0 to 7.0% Sm, 1%-2% Zr, 48% to 62% Co, 15% to 25% Fe, and 9.5% to 11.5% Cu, wherein the alloy casting has a microstructure having a 1:7 Ce-based main matrix phase in the as-cast condition or in the cast and as-heat treated condition.

9. The alloy casting of claim 8 having a composition (in atomic %) of 13.8% to 14.2% Ce, 0 to 4.0% Sm, 1.6% to 2.5% Zr, 51% to 58% Co, 16.5% to 22.5% Fe, and 10.1% to 11.2% Cu.

10. A method of casting a molten 1:7 Ce-based alloy wherein casting is conducted using a temperature-time profile that starts with a superheat temperature just above the alloy melting point for a time effective to melt all solid alloy charge components followed by a dwell period at a lower temperature below the alloy melting temperature and then by cooling to room temperature, said temperature time profile reducing formation of magnetic impurity phase(s) so that a cast microstructure having a 1:7 Ce-based main matrix phase in the as-cast condition is produced for improved extrinsic magnetic properties.

11. The method of claim 10 that includes (REE, Co)-rich phase(s) at stacking faults of the matrix phase wherein REE can be Ce or Ce and Sm.

12. The method of claim 10 that includes a secondary magnetic impurity phase dispersed in the main matrix phase.

13. The method of claim 10 wherein the Ce-based alloy has a composition (in atomic %) of: 7% to 15.2% Ce, 0 to 7.0% Sm, 1%-2% Zr, 50% to 60% Co, 15% to 25% Fe, and 9.5% to 11.5% Cu.

14. The method of claim 10 wherein the superheat temperature is limited to 10° C. above the alloy melting temperature.

15. The method of claim 10 wherein the alloy is melted in a crucible.

16. The method of claim 15 wherein the alloy is melted by induction heating in the crucible.

17. The method of claim 15 wherein alloy solidification is conducted in the crucible.

18. The method of claim 15 wherein the alloy is poured from a bottom discharge opening of the crucible.

19. The method of claim 18 wherein the alloy is bottom poured into a mold.

20. The method of claim 12 wherein the impurity phase(s) is/are present in an amount of 5 to 8 volume %.
